(19) United States
(12) Patent Application Publication
(10) Pub. No.: US 2012/0237612 A1
(43) Pub. Date: Sep. 20, 2012

(54) Ultrasound Gel And Methods Of Manufacturing Same

(76) Inventor: Jeffrey L. Lampe, Rocheport, MO (US)

(21) Appl. No.: 13/419,939

(22) Filed: Mar. 14, 2012

Related U.S. Application Data
(60) Provisional application No. 61/452,539, filed on Mar. 14, 2011.

(51) Int. Cl. A01N 59/16; A01P 1/00; A01N 37/52

(52) U.S. Cl. 424/618; 514/635

(57) ABSTRACT

Ultrasound gels and methods for making ultrasound gels are disclosed herein. According to one embodiment, a gel for use with an ultrasound machine comprises glycerol and a composition. The composition in-turn comprises chlorhexidine gluconate and propylene glycol.

### CROSS-REFERENCE TO RELATED APPLICATIONS

The present application claims priority to U.S. Provisional Patent Application No. 61/452,539, filed Mar. 14, 2011, and titled “Ultrasound Gel and Methods of Manufacturing Same”, the disclosure of which is incorporated herein by reference.

### FIELD OF THE INVENTION

The invention relates generally to the field of ultrasound gels. More specifically, the invention relates to the field of ultrasound gels that can be used in phonophoretic applications.

### BACKGROUND

Ultrasound based medical imaging techniques have been used to visualize organs, muscles, tendons, etc., in bodies for several decades. Ultrasound procedures utilize high frequency sound waves that are beamed into the body. These waves reflect off structures underneath the skin, creating echoes that can then be used to visualize the structures. Specifically, an ultrasound scanner, also known as a transducer, may be used to send out the high frequency sound waves into a body. As sound waves travel through different materials at varying speeds depending on, for example, the density and compressibility of the materials, the sound waves, after reflecting off structures in the body, bounce back at different intervals depending on the type of material they pass through. The reflected waves are picked up by the transducer and relayed to a machine, which displays the distances and intensities of the reflected waves in the form of an image.

Ultrasound waves travel poorly through air. As such, because of the air between the transducer and the skin, it is generally undesirable to place a transducer directly over the skin of a patient. Conductive ultrasound gels may be used to counter this problem. Before placing the transducer on the skin, these gels are applied to the skin's surface, so as to provide a conductive medium between the transducer and the skin for the traveling and interception of ultrasound waves.

Phonophoresis refers to a process of using ultrasound waves to enhance the delivery of topically applied drugs. Ultrasound waves may create heat, increase drug molecule movement, and improve circulation by opening hair follicles and sweat glands, allowing for a topically applied drug to penetrate into the skin. Analgesics and anti-inflammatory medications, for example, may be delivered by phonophoresis. Some studies have shown that phonophoretically administered medications may penetrate the body at a deeper level than drugs that are massaged by hand over the skin's surface. Additionally, unlike medications that are taken orally, which disperse over and affect the entire body, phonophoresis may allow a medication to target only a specific affected area of the body. Research is underway to ascertain optimal techniques and conditions for safe and efficacious utilization of phonophoresis.

Ultrasound machines, in conjunction with ultrasound gels, may also be utilized to aid in the placement of local injections and peripherally inserted central catheter lines (“PICC” lines). A PICC line is a form of intravenous access that can be used for prolonged periods of time. A PICC line is generally inserted in a peripheral vein, such as the basilica vein, the brachial vein, or the cephalic vein, and thereafter advanced through increasingly larger veins. As the insertions of PICC lines and local injections involve rupturing of the skin, it is essential that the ultrasound gel used in these and similar applications be sterile. As disclosed herein, the ultrasound gel used in the placement of a PICC line may also have medicinal properties. For example, the ultrasound gel may be antibiotic, so that such antibiotic can be phonophoretically administered during the placement of the PICC line. The current invention discloses such a sterile ultrasound gel and methods of making the same.

### SUMMARY

Ultrasound gels and methods for making ultrasound gels are disclosed herein. According to one embodiment, a gel for use with an ultrasound machine comprises glycerol and a composition. The composition in-turn comprises chlorhexidine gluconate and propylene glycol.

According to another embodiment, an ultrasound gel comprises glycerol and a sterilizing composition. The sterilizing composition comprises at least one of chlorhexidine gluconate and silver nanoparticles.

### BRIEF DESCRIPTION OF THE DRAWINGS

Illustrative embodiments of the present invention are described in detail below with reference to the attached drawing figures, wherein:

FIG. 1 shows a Petri dish containing agar inoculated with Escherichia coli, and having a slide that is partly covered with a gel including nano silver according to an embodiment; and

FIG. 2 shows a Petri dish containing agar inoculated with Escherichia coli, and having a slide that is partly covered with a gel.

### DETAILED DESCRIPTION

Placement of a PICC line may take over an hour, or even longer. As such, a gel used in conjunction with an ultrasound transducer for such placement may need to meet several criteria. For instance, the gel, which may initially be sterile, should preferably remain sterile for extended periods of time. Further, the gel should preferably have a low vapor pressure, such that the gel does not generally evaporate during the time that the PICC line is being placed. The gel also needs to have a high viscosity, such that the gel remains in place during the placement of the PICC line, and it may be desirable for the gel to be colored, or have other indicia to help identify the gel after it is applied to the skin. Finally, as the gel is being used in conjunction with an ultrasound transducer, it must be electrically conductive, and provide a lubricated surface for the transducer.

In various embodiments of the current invention, to sterilize an ultrasound gel, an appropriate quantity of chlorhexidine gluconate (CHG) solution may be mixed into the gel. A relatively concentrated solution, such as a 20% w/v CHG solution may be initially obtained, and diluted to achieve a final CHG concentration of about 4% in the gel, or another desired concentration. The CHG may integrate better into the gel if the CHG solution, or both the gel and the CHG solution, are heated to a desired temperature before mixing.

Propylene glycol may be used as the solvent in the CHG solution. Propylene glycol has emulsifying properties, which help increase the viscosity of the gel. Propylene glycol also has humectant properties, and when mixed with the ultrasound gel, may promote the absorption and retention of water in the gel, allowing the gel to remain moist and lubricated. The humectant properties may also be helpful as an antibiotic.

Nanotechnology has been employed to drastically reduce the size of silver particles, to between 1 and 100 nanometers. These silver nanoparticles may have antimicrobial properties. A substance comprising silver nanoparticles may be mixed into the gel for sterilization. For example, a powder based additive having 500 ppm nano silver may be mixed into the gel to provide an additional kill agent along with (or in some embodiments, instead of) the CHG.

Glycerol (glycerine) may be used as the backbone of the gel. Glycerol has antibiotic and humectant properties, and may improve the smoothness and lubrication of the gel. Moreover, glycerol is highly viscous, which may allow the gel to stay in place during the placement of the PICC line. Glycerol also has a low vapor pressure, which may prevent the gel from evaporating while the PICC line is being placed.

Glycerol, however, is generally colorless, and while not necessary, it may be preferable that the gel be colored so that it can be identified after being applied to the skin's surface. Food coloring, for example, could be added to allow the gel to be easily identifiable. But, as food coloring may not be sterile, a sterile color additive may be used instead to help identify the gel.

Commonly available Knox Gelatine, KNOX being a registered trademark of NBTY, Inc., may be used as the gelling agent. But as Knox Gelatine is not a sterile substance, it may be desirable to limit its use, and in clinical settings, a sterile hydrogel may be used instead.

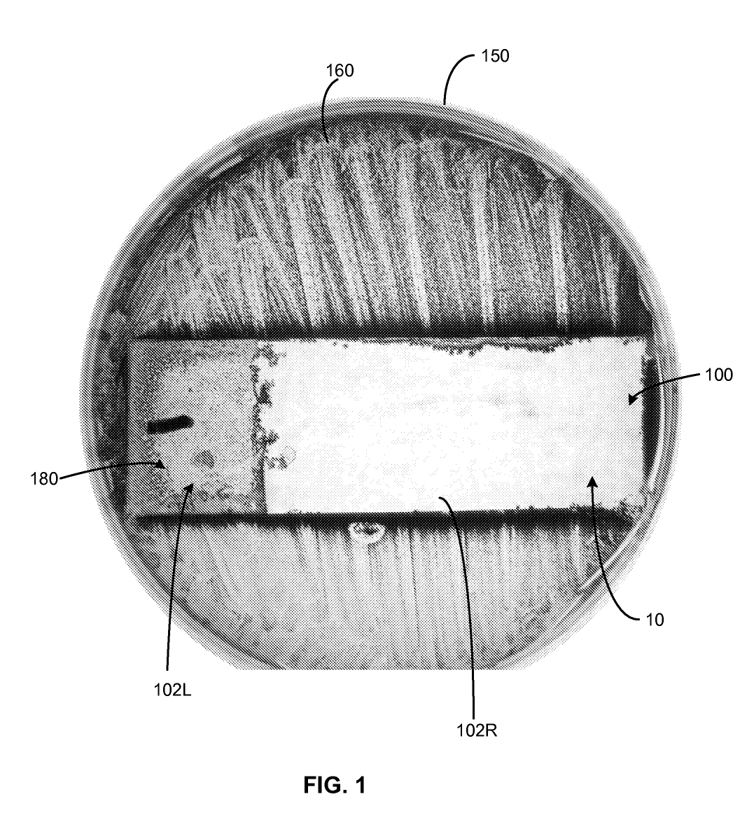

Experimentation has shown that a gel 10, as described above with both CHG and nano silver, is generally sterile, and can desirably inhibit bacterial growth. FIG. 1 shows a slide 100 having a left side 102L, and a right side 102R; gel 10 was applied only on the right side 102R, and the slide 100 was then placed, gel-side down, in a Petri dish 150. The Petri dish 150 contained agar 160 inoculated with Escherichia coli (“E. coli”). As evident from FIG. 1, when the slide 100 is viewed, gel-side up, the left side 102L has significant bacteria growth 180; on the right side 102R, conversely, bacteria is generally eliminated (or at least prevented) because of the gel 10.

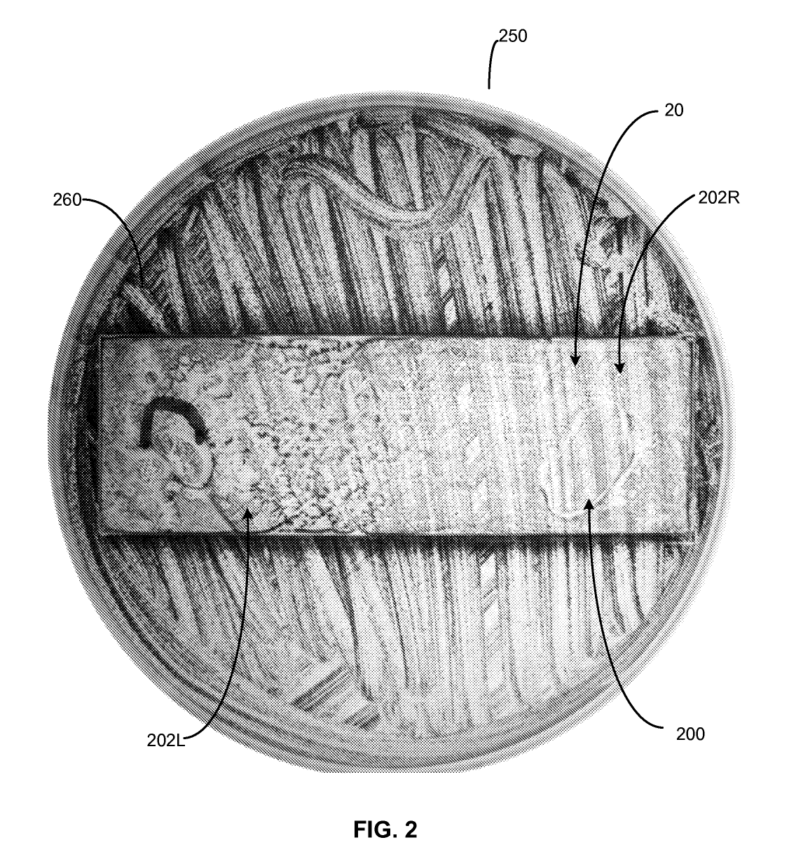

FIG. 2 shows a slide 200 having a left side 202L and a right side 202R. Here, gel 20 was applied on the right side 202R, a primary difference between gel 10 and gel 20 being the absence of any nano silver in gel 20. The slide 200 was then placed, gel-side down, in a Petri dish 250. Akin to Petri dish 150, Petri dish 250 contained agar 260 inoculated with E.coli. As shown in FIG. 2, when the slide 200 is viewed, gel-side up, the left side 202L without gel 20 has more prominent bacteria growth than the right side 202R on which the gel 20 had been applied. Nevertheless, bacteria elimination/prevention is much more pronounced at 102R than at 202R, as can be seen by comparing the figures.

Because of their antimicrobial and antibiotic properties, the gels 10, 20 may be used to prepare/sterilize the dermis and epidermis of humans and animals before the ultrasound transducer is utilized to locate these humans' and animals' desired internal portions. The gels 10, 20, thus, eliminate the need to separately prepare/sterilize patients for phonophoretic drug applications, and enhance the effectiveness with which bacteria is killed during phonophoresis.

It has also been found that the lifespan of the CHG, by virtue of being in the gels 10, 20, may be extended; specifically, testing showed that the CHG in the gels 10, 20 may last for over a day, which may make the gels 10, 20 very desirable for use in placing PICC lines.

Many different arrangements of the various components depicted, as well as components not shown, are possible without departing from the spirit and scope of the present invention. Embodiments of the present invention have been described with the intent to be illustrative rather than restrictive. Alternative embodiments will become apparent to those skilled in the art that do not depart from its scope. A skilled artisan may develop alternative means of implementing the aforementioned improvements without departing from the scope of the present invention.

It will be understood that certain features and subcombinations are of utility and may be employed without reference to other features and subcombinations and are contemplated within the scope of the claims. Not all steps listed in the various figures need be carried out in the specific order described.

The invention claimed is:

1. A gel for use with an ultrasound machine, the gel comprising:
glycerol; and
a composition comprising:
chlorhexidine gluconate; and
propylene glycol.

2. The gel of claim 1, wherein the concentration of chlorhexidine gluconate in the gel is about 4%.

3. The gel of claim 2, further comprising an additive having silver nanoparticles.

4. The gel of claim 3, wherein the additive has about 500 ppm of silver nanoparticles.

5. The gel of claim 1, further comprising an additive having silver nanoparticles.

6. An ultrasound gel comprising:
glycerol: and
a sterilizing composition comprising at least one of:
(a) chlorhexidine gluconate; and
(b) silver nanoparticles.
